(19) United States
(12) Patent Application Publication
(10) Pub. No.: US 2016/0171813 A1
(43) Pub. Date: Jun. 16, 2016

(54) Table Gaming Management System

(71) Applicant: Bruce Merati, San Diego, CA (US)

(72) Inventor: Bruce Merati, San Diego, CA (US)

(21) Appl. No.: 14/952,034

(22) Filed: Nov. 25, 2015

Related U.S. Application Data
(63) Continuation-in-part of application No. 29/519,689, filed on Mar. 6, 2015.
(60) Provisional application No. 62/092,770, filed on Dec. 16, 2014.

(51) Int. Cl. G07F 17/32

(52) U.S. Cl. CPC G07F 17/326

(57) ABSTRACT

Various embodiments of a random game value generator are described for preforming one or more actions in response to detected events that occur at a gaming establishment. In one embodiment, the random game value generator generates random, physical game values for use in a non-electronic game played in the gaming establishment, comprising a sensory output device disposed around the random game value generator, a memory for storing processor-executable instructions and a processor, coupled to the sensory output device and the memory, for executing the processor-executable instructions that cause the random game value generator to determine that an event related to a gaming establishment has occurred while the non-electronic game is played that uses at least some of the plurality of physical game values, and in response to determining that the event has occurred, enable the sensory output device for a predetermined time period.

### I. CROSS-REFERENCE TO RELATED APPLICATIONS

This application claims the benefit of U.S. provisional patent application No. 62/092,770, filed on Dec. 16, 2014 and design patent No. 29/519,689 filed on Jun. 3, 2015, owned by the inventor of the present application and are incorporated by reference herein.

### II. FIELD OF USE

The present application relates generally to casino style gaming, and more specifically to physical random number generators and related systems, whether played for real money or entertainment.

### II. DESCRIPTION OF THE RELATED ART

Most live games played in casinos or gaming establishments are either table games such as blackjack or baccarat, or ball-drawn games such as bingo or keno. For determining the outcome of these games, a physical device, such as a set of shuffled playing cards, are drawn from a shoe, or numbered balls are drawn from a container or a ball blower. These devices perform as random number generators for determining outcome of the games. The methods of offering and managing live games have remained the same since they were first introduced into casino floors decades ago. On the other hand, electronic games such as slot machines have gone through significant technological evolutions over the last couple of decades.

To provide random values and to prevent players from having an advantage by knowing the position of a specific card or groups of cards in a shoe, a dealer either manually shuffles the cards or uses an automatic shuffler before placing them in a shoe and then cuts the decks using a cut-card to separate some of the cards at the back of the shoe from being dealt. The gaming industry also has developed mechanical devices such as continuous shufflers or hands-free ball blowers to automatically shuffle and randomly deliver one or more cards or balls at a time. For some games such as baccarat, technologies are developed to recognize and communicate the value of the cards at the time they are taken out of the shoe for display on a monitor at the table the outcome and history of the game for Bank, Player or Tie wining hands.

It would be desirable for a physical random number generator to communicate with other devices including, sensors, processors, image recognitions, RFID's, and other bet or win recognition technologies as well as player tracking systems and devices to issue promotional offers and create player excitements with display of graphical animations and sound effects on occurrence of certain events such as a player's win or a dealer's loss.

### SUMMARY

Various embodiments of a random game value generator are described for preforming one or more actions in response to detected events that occur at a gaming establishment. In one embodiment, the random game value generator generates random, physical game values for use in a non-electronic game played in the gaming establishment, comprising a sensory output device disposed on or around the random game value generator, a memory for storing processor-executable instructions and a processor, coupled to the sensory output device and the memory, for executing the processor-executable instructions that cause the random game value generator to determine that an event related to a gaming establishment has occurred while the non-electronic game is played that uses at least some of the plurality of physical game values, and in response to determining that the event has occurred, enable the sensory output device for a predetermined time period.

In another embodiment, a method is described, performed by a random game value generator for generating random, physical game values used in a non-electronic game in a gaming establishment, the method comprising determining that an event related to the gaming establishment has occurred while the non-electronic game is played, and in response to determining that the event has occurred, enabling a sensory output device located on or around the random game value generator.

### BRIEF DESCRIPTION OF THE DRAWINGS

The included drawings are for illustrative purposes and serve only to provide examples of possible structures and arrangements for the disclosed inventive apparatuses, systems and methods. While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order.

The features, advantages, and objects of the present invention will become more apparent from the detailed description as set forth below, when taken in conjunction with the drawings in which like referenced characters identify correspondingly throughout, and wherein:

FIG. 1 illustrates one embodiment of a gaming system, comprising a gaming area for allowing players to play a non-electronic game using one or more non-electronic random number generators;

FIG. 2 is a perspective view of one embodiment of a double deck card shoe used to generate physical game values for a primary, non-electronic game and to generate secondary game values for a secondary game, side bet, or other consideration;

FIG. 3 is a functional block diagram of one embodiment of the double deck card shoe shown in FIG. 2;

FIG. 4 is a flow diagram illustrating one embodiment of a method for providing audio and visual responses to certain events as they occur in a gaming establishment;

FIGS. 5a and 5b are perspective views of another embodiment of a double deck card shoe used to generate physical game values for a primary, non-electronic game and to generate secondary game values for a secondary game, side bet, or other consideration, having two levers to block/allow access to each shoe as a game is being played; and

FIGS. 6a and 6b are perspective views of yet another embodiment of a double deck card shoe used to generate physical game values for a primary, non-electronic game and to generate secondary game values for a secondary game, side bet, or other consideration, having a single lever to block/allow access to each shoe as a game is being played.

### DETAILED DESCRIPTION

Embodiments of the present invention comprise a random game value generator, such as a card shoe, double deck card shoe, bingo ball cage, roulette wheel, wheel of fortune, dice, keno ball cage, or other device for generating physical game values for use with a non-electronic game, having at least one sensory output device such as bells, whistles, blinking LED lights, electronic displays, etc., that are energized or enabled for a predetermined time period upon the occurrence of one or more events that may occur in association with a gaming establishment. The events may comprise conditions that may occur during a non-electronic casino game such as Blackjack, poker, roulette, Bingo, Keno, etc., and/or they may comprise conditions that are unrelated to a game but occur in a gaming establishment, such as when a seat becomes open, a reservation becomes available at a restaurant, a ticket becomes available for a show, etc. In this way, non-electronic games may become more exciting and could help casinos increase patron playtime. The term “non-electronic games”, as used herein, comprises any game that utilizes physical game values (as opposed to electronically-generated ones) as a random number generator, such as playing cards, dice, a roulette wheel, a wheel of fortune, bingo balls, keno balls, or other physical devices.

In one embodiment, a second random game value generator may be used in conjunction with a primary random game value generator, to offer game variations to players without disturbing the natural “flow” of game values from the primary random game value generator. For example, in certain games, such as blackjack, psychology and emotion may play a major role in determining things such as how much money to bet on each hand, whether to play in accordance with the best mathematical strategy, or when to deviate from optimal basic strategy. Certain players may feel uncomfortable receiving cards out of the sequence that they were placed in a shoe. The addition of a second random game value generator, such as a second shoe, allows variations to a primary game without disrupting the order of cards that are provided for the primary game.

Electronic gaming machines such as slot machines use flashing lights and sound effects to capture a player's interest in the game. The sound effects and the lightings around a slot machine's peripherals are designed to provide a series of orchestrated animations that attracts a player's attention when a player wins or hits a jackpot. On the other hand, no lighting or sound technology has been incorporated into table games such as a traditional blackjack hosted by a live gaming establishment employee, otherwise known as a dealer, to celebrate a player's win or a dealer's bust to create excitement at a game table. Thus, the same kind of electronic excitement provided by slot machines may now be incorporated into table games, based on the teachings herein.

The use of the term “physical” herein denotes a two or three-dimensional object. For example, “physical game values” may include such things as playing cards, bingo balls, mechanical dice, mechanical roulette wheels, mechanical wheels of chance, or any tangible object capable of generating random numbers or game values.

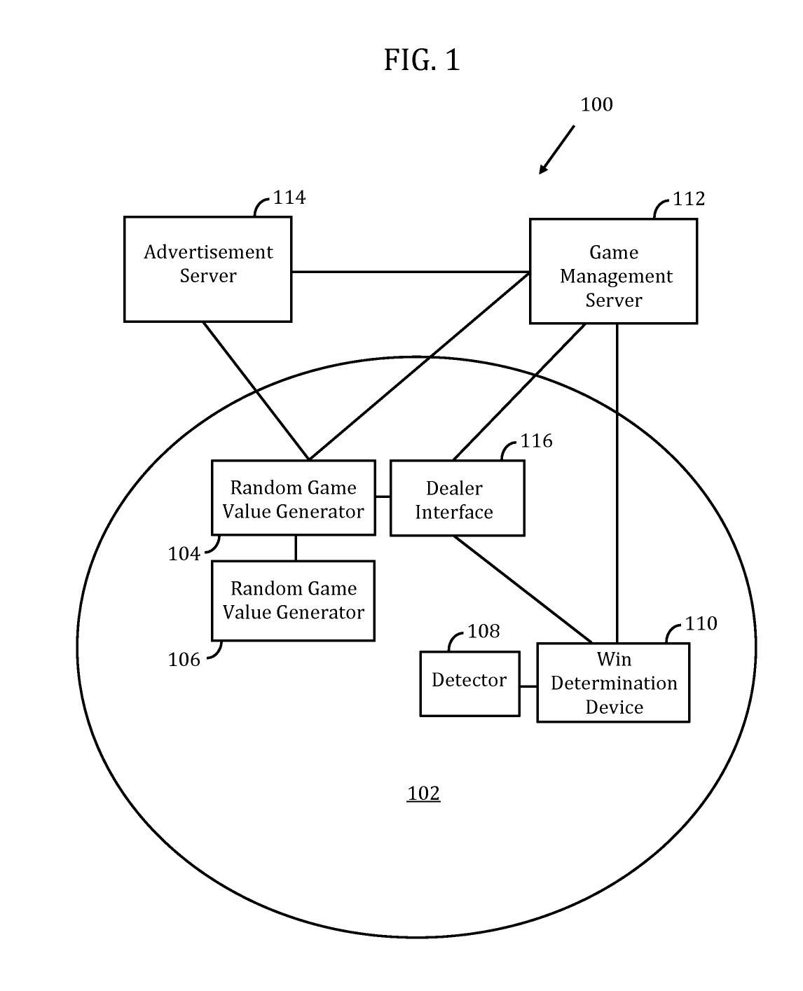

FIG. 1 illustrates one embodiment of gaming establishment 100 comprising gaming area 102 for allowing players to play a game using one or more random number generators associated with the gaming area. In the example of FIG. 1, gaming area 102 comprises a casino gaming table, constructed to allow a number of players to play a game against a house entity (e.g., blackjack, baccarat, roulette, craps, or keno), against a live/robotic dealer or against other players hosted by a live/robotic dealer (i.e., Texas Hold'Em, draw poker, stud poker, bingo). Gaming tables that use playing cards often seat seven to ten players at a felt-covered table with designated locations on the table for players to place casino chips as their wagers and to receive cards. In other embodiments, gaming area 102 may comprise a poker table, a roulette table, a craps table, a bingo auditorium, etc. The gaming establishment 100 further comprises a first random game value generator 104 and an optional second random game value generator 106. In this example, first and second random game value generators 104 and 106 each comprise a mechanical “card shoe” for holding physical playing cards. Shoes are commonly used in the casino industry to facilitate dealing cards, and to minimize fraud and card counting. They typically comprise an elongated housing and a roller to push down the cards in the shoe, and an opening to facilitate the top card in the stack to be dealt from the shoe one card at a time. In other embodiments, random game value generator 104/106 could comprise an automatic shuffling device, which is a mechanical or electro-mechanical device for shuffling one or more decks of physical playing cards. In another embodiment, random game value generator 104/106 comprises a bingo ball “cage”, dice, a roulette wheel, a “wheel of chance”, or any tangible object capable of generating random numbers or game values. In some embodiments, the first and second random game value generators are of the same type. In other embodiments, they are of different types. The remaining discussion presented herein with respect to random game value generators 104 and 106 will assume that they each comprise a card shoe, for purposes of brevity and clarity. However, it should be understood that in other embodiments, one or both random game value generators could comprise different combinations of random game value generators, as listed above.

As cards are dealt from first random game value generator 104, they are passed across detector 108 for detector 108 to determine a game value associated with each card. The determined game values are converted into “electronic game values” representative of the physical game values for transmission to one or more other devices. Detector 108 typically comprises an optical scanning device commonly found in many casinos today that uses light technology to read cards as they are dealt from random game value generator 104. In other embodiments, detector 108 comprises an RFID reader, where the physical game values comprise RFID tags. In yet other embodiments, detector 104 is co-located with, or integrated with, random game value generator 104, such that game values are determined as cards are dealt from random game value generator 104.

The game values determined by detector 108 are provided to either win determination device 110 and/or game management system 112, in order for one or both of these devices to track and determine winning combinations of game values provided to each of the players at gaming area 102, losing combinations of game values to a dealer, or other events that may occur in a casino gaming environment. In another embodiment, dealer interface 116 is used by a live dealer, either alone or in combination with win determination device 110 and/or game management system 112, to provide an indication when winning/losing combinations of game values are provided to the players and/or other events. For example, in one embodiment, dealer interface 116 comprises an electronic device having pre-labeled pushbuttons thereon, indicative of events that may occur during a game of Blackjack. For example, two buttons could be defined: Dealer Bust and Player Blackjack. When either of these events occurs during game play, the dealer presses a respective pushbutton, which provides a signal to random game value generator 104, 106 or both, to perform one or more actions. In another example, dealer interface 116 is used to enter the number of players who play each round of game play, so that win determination device 110, game management system 112, and/or random game value generator 104/106 may determine winning/losing game outcomes for each player and/or the dealer. Dealer interface 116 may further provide signals to win determination device 110, game management system 112, and/or random game value generator 104/106 to indicate the start or completion of a round of game play. Dealer interface 116 is electronically coupled to win determination device 110, game management system 112, and/or random game value generator 104/106 in order to provide information as described above via wired or wireless links, well known in the art. In one embodiment, dealer interface 116 forms part of random game value generator 104/106, while in another embodiment, dealer interface 116 comprises a portable consumer device, such as a smartphone, tablet, desktop or laptop computer.

Win determination device 110 comprises a computing device comprising a game value interface, a processor, a memory, and an output communication interface, for receiving the game values as determined by detector 108, and determining one or more winners of each game. Examples of win determination device 110 include a dedicated portable computer, fixed computer, or a device specially designed to perform the functions of win determination device 110. Game detector 108 and win determination 110 may use optical cameras or RFID technologies to determine a physical game value. Win determination device 110 may know how many players are at gaming area 102. The determination of number of players at a table could be through optical cameras identifying the wager of a player, RFID readers underneath the felt of a table communicating with the RFID chips embedded in the playing cards placed in front of a player, sensors underneath the table detecting placement of cards in front of a player or via input from dealer interface 116. Use of these techniques establish which game values are associated with each player, so that win determination device 110 may associate winning and/or losing hands of each game player, and provide those results to game management system 112 via its output communication interface, which may comprise well-known wireless or wired technology. Game management system 112 receives the information from win determination device 110 and may take a number of actions in response thereto. For example, game management system 112 may comprise a game rewards system for awarding rewards points to players, based on metrics such as how long a player has been playing, how many hands or games a player has won or lost, the amount of each player's wagers, etc. Such information may be provided by, or deduced from, the information provided by win determination device 110. Such rewards points are credited to each player in accordance with the rules in effect at each gaming establishment, typically by accessing an account held by each player and increasing a number of rewards points available for use by each player.

Game management system 112 comprises one or more computers configured to track gaming results that occur in a casino gaming environment. For example, game management system 112 may be configured to track the number of poker hands played, the number of Blackjack hands played, the number of slot machine pulls, the number of roulette wheel spins, etc. that occur at a particular casino. Game management system 112 may also manage a rewards points system, where players earn redeemable rewards points based on the number of hands they play and/or the cumulative amounts that they wager. Game management system 112 may also be configured to determine game results based on electronic game values provided by various detectors 108 distributed throughout a casino, using processor-executable instructions well-known in the art for determining game results of a number of casino game, such as various forms of poker, Blackjack, etc.

In one embodiment, win determination device 110 is not used. Rather, detector 108 comprises communication technology to provide the game values to game management system 112, and game management system 112 performs the aforementioned duties of win detection device 110, such as win/loss determination for each player at gaming area 102, as well as other gaming areas. In another embodiment, the functions of win determination device 110 are incorporated into detector 108, whether a stand-alone device or incorporated into random game value generator 104.

When an event is detected by any of the above-mentioned devices (e.g., a win, a loss, a dealer “bust”, a player “folds”, a “raise” occurs, “bingo” is detected, a keno match is detected, or some other event associated with the game), random game value generator 104 is notified of such an event by win determination device 110, game management system 112, or detector 108, and in response, random game value generator 104 “celebrates” the event by performing one or more actions, such as causing lights to be illuminated, located on or around random game value generator 104 and/or in gaming area 102 (for example, a series of LED lights on random game value generator 104, incorporated into a gaming table, indoor lighting, etc.), causing an audible signal, such as music, to play via one or more speakers located within random game value generator 104 or within gaming area 102, causing a video to be displayed on random game value generator 104 or within view of gaming area 102, etc. Such audio and visual effects have shown to be a popular way to attract and retain players' interest for slot machines, which are designed to run a series of orchestrated animations that attracts players' attention when a player wins or hits a jackpot. Random game value generator 104 is configured to provide a similar type of exciting stimulus to card games, bingo, roulette, etc.

In one embodiment, random game value generator 104 comprises one or more manual inputs alternatively or in addition to receiving event occurrence information. Such manual inputs may be used by a dealer or other casino employee to manually trigger one or more actions by random game event generator 104. Such manual inputs may comprise one or more pushbuttons, switches, knobs, or other similar devices that cause random game event generator 104 to take one or more of the actions described above.

In another embodiment, a second random game value generator 106 is used during game play at gaming area 102. Traditionally, table games use only one random game value generator, such as a single shoe, single ball-blower, single roulette wheel, single set of dice, etc., to play games. Adding a second random number generator, such as a second shoe or a second set of ball blowers provides an additional set of random game values for enhancing a traditional game's offerings. The second set of random game values allows variations of traditional games, and/or addition games, to be played. Such variations may include the addition of side bets to traditional games, promotional offers, advertising, etc., without affecting the way the traditional game is dealt and played.

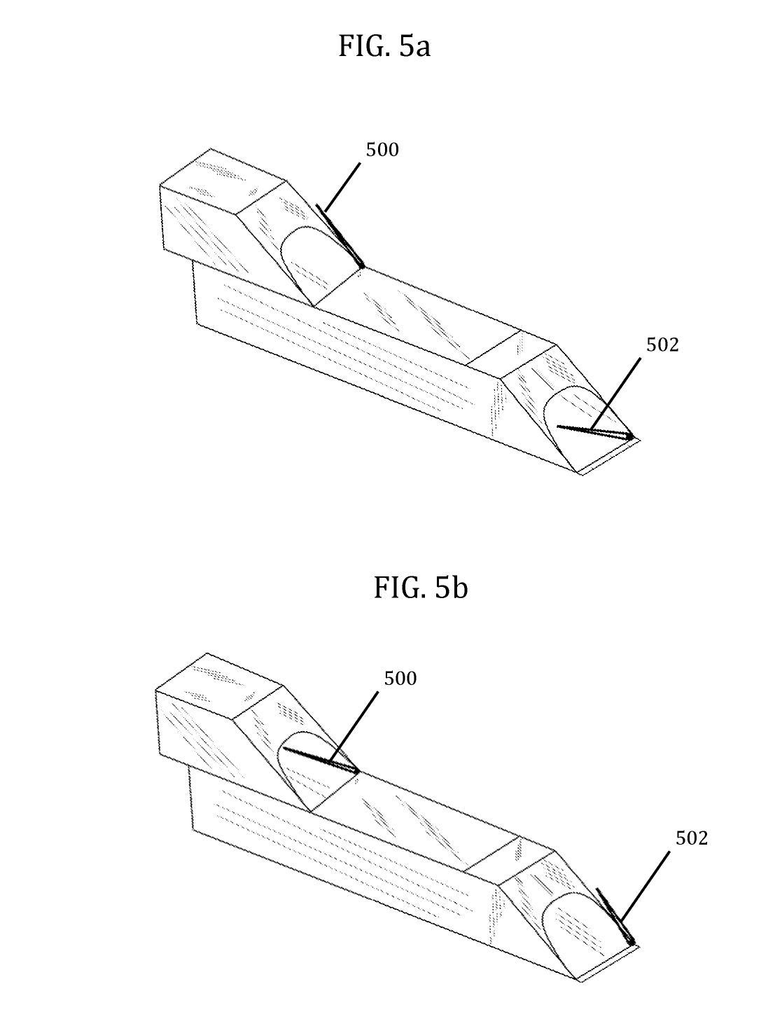

To facilitate the use of second random game value generator 106 in an embodiment where the first and second game value generators are card shoes, motorized levers or illuminating lighting devices could provide a signal to the dealer as to which shoe to draw from next, as shown in FIGS. 5a and 5b. The lever's movement may be managed by win determination device 110, game management system 112, or detector 108 as any of these devices determine that a game value should be drawn from one random game value device or the other. This may help reduce mistakes made by a dealer in drawing from a wrong shoe, for example. The motorized levers may be automatically controlled to physically allow only one of two or more random game value generators to provide a random game value, such as when the lever physically blocks cards from being dealt by random game value generator 104, while the lever allows cards to be dealt from random game value generator 106. FIG. 5a shows a double deck card shoe with lever 502 being in a blocked position, preventing cards in the lower shoe from being dealt, while lever 500 is in an “allowed” position, allowing cards to be dealt from the upper shoe. Conversely, FIG. 5b shows the same double deck card shoe with lever 502 being in an allowed position, allowing cards in the lower shoe to be dealt, while lever 500 is in a blocked position, preventing cards from being dealt from the upper shoe.

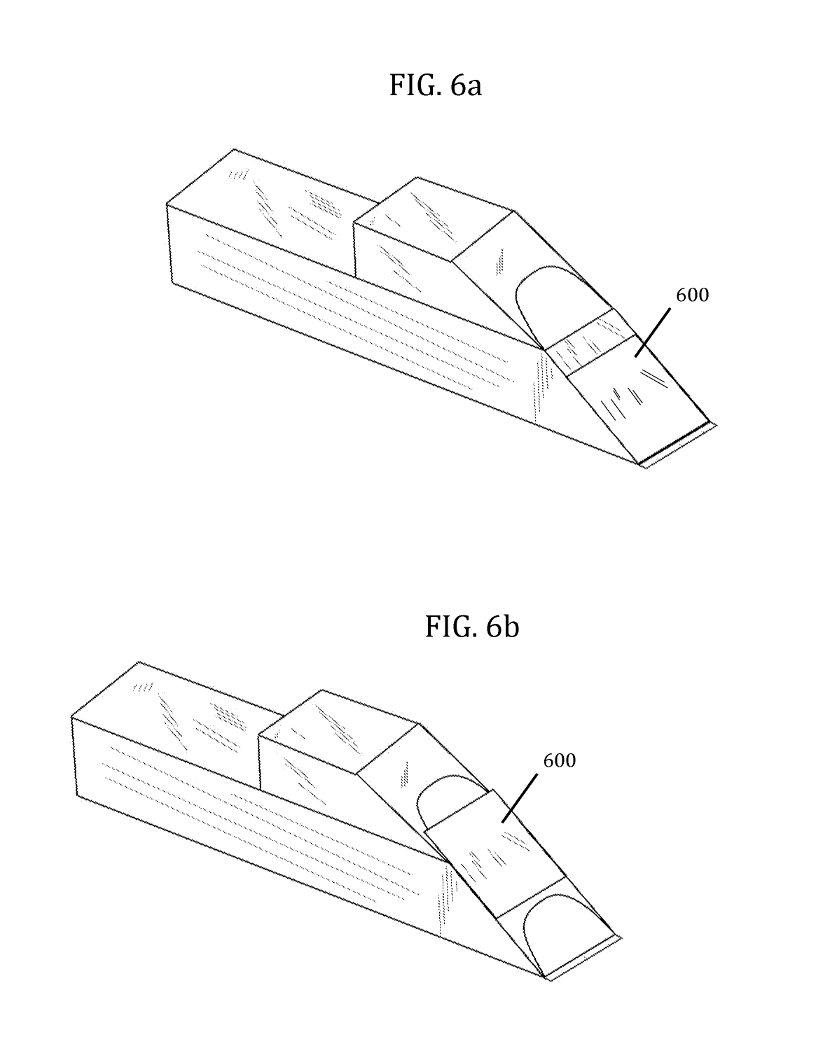

In one embodiment, random game value generator 106 is co-located with random game value generator 104, such that only a single lever may be used to simultaneously block one random game value generator from providing game values while allowing the other random game value generator to do so, as shown in FIGS. 6a and 6b. In another embodiment, one or more lights, such as one or more LEDs, may be illuminated by a signal from win determination device 110, game management system 112, or detector 108 to indicate to a dealer which random game value generator to use to provide the next game value. FIG. 6a shows a double deck card shoe with lever 600 being in a blocked position with respect to the lower card shoe, preventing cards in the lower shoe from being dealt while allowing cards from the upper shoe to be dealt. Conversely, FIG. 6b shows the same double deck card shoe with lever 600 being in a blocked position with respect to the upper card shoe, preventing cards in the upper shoe from being dealt while allowing cards from the lower shoe to be dealt. Lever 600 is typically coupled to a motor or motor coupling inside either the upper or lower shoe that moves lever 600 up and down in response from signals from win determination device 110, game management system 112, a processor within the upper or lower card shoe, or detector 108.

It should be noted that the term “lever” in this application is used broadly to mean any device placed around the sloping front of a playing card shoe as a barrier to block cards from being drawn from the sloping finger-sized opening in front of the shoe that allows a dealer to draw cards, one at a time, from a stack of cards that are normally placed in a tilted position inside the shoe. The device could comprise different shapes or forms and could be as simple as a rigid bar that turns around a pivot point in front of the opening or it could be a flat or a sloping surface that either engages edge-to-edge in front of the opening or has sufficient width or height to prevent the dealer from exerting finger pressure on the forward-most card to draw the card downwardly through the opening and extracting it from top of the stack of cards inside the shoe. Regardless of the type of device used, its mechanism will allow the lever to move between a blocking position and an unblocking position in front of the shoe. The unblocking of one shoe may correspond with blocking of the other shoe, both of which may be initiated based upon receiving signals from win determination device 110, game management system 112, or detector 108 so that, at anytime during the game, the dealer could only draw cards from one of the two shoes.

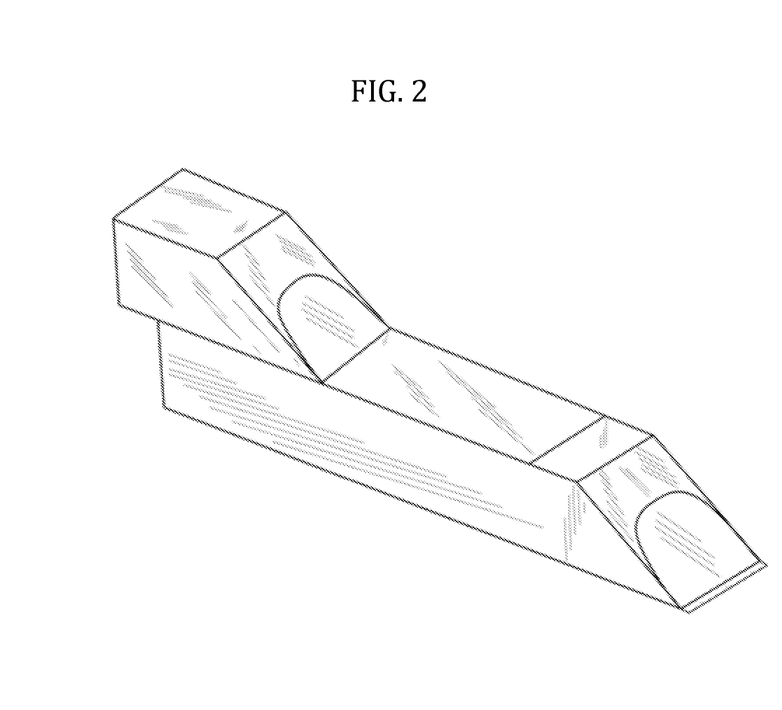

An illustration of how the addition of a second card shoe could add another game or wager to an existing game is an addition of an optional side wager to a regular game of blackjack. For example, a dealer at a blackjack table may use the main shoe (random game value generator 104) to deal cards for a regular blackjack, and also draw three cards from a second shoe (random game value generator 106) as community cards for a side 5-card poker hand made up of the three common cards drawn from the second shoe plus each player's initial two blackjack cards dealt from the main shoe. To save space on the gaming surface and the flow of dealing cards, the second shoe could be placed on the main shoe creating a double deck card shoe shown in FIG. 2. In another embodiment, the double deck card show shown in FIG. 2 may be manufactured as a single unit.

After the initial 2 blackjack cards are provided to each of the players, the lever may be automatically re-positioned and/or light(s) illuminated by the first shoe so that only cards from the second shoe may be drawn, to provide the three community cards, and/or to provide a visual cue to the dealer from which shoe to deal from. Once it has been determined that the three cards have been drawn from the second shoe, the lever may be re-positioned to only allow farther cards to be drawn from the first shoe, and/or another light(s) illuminated/extinguished to provide a visual cue to the dealer from which shoe to draw cards from next.

Another illustration of how the addition of a second shoe could enhance an existing card game is to allow players to select a shoe from which to receive their next card. For example, if a blackjack player is looking to receive a high card, but has determined that a number of high cards have been dealt from a main shoe, that player may be allowed to have the dealer provide his or her next card from a second shoe.

In yet another illustration of how the addition of a second shoe could add another game or wager to an existing game is the addition of a multiplier to a table game. For example, a side wager may be available to players where players' winnings could be multiplied by a number shown on a randomly drawn multiplier card drawn from the second shoe.

A similar concept can be applied to non-card games. For example, in bingo, a first bin of physical bingo balls may be used to complete a first bingo game (e.g., a straight line), while a second bin of physical bingo balls may be used to continue the game to a more complex result (e.g., an “X”). In craps, a first set of physical dice may be used to play a traditional game of craps, while a second set of physical dice may be used for wagers involving side bets.

In another embodiment, the random game value generators may comprise different physical characteristics from one other. For example, in one embodiment, a first random game value generator may comprise a single, or multiple, deck(s) of physical playing cards in a card shoe, while a second random game value generator may comprise playing cards having different game values, such as a multiplier. The multiplier may be a physical spinning “wheel of fortune” having one or a number of game values pertinent to the game being played, a physical bin of physical objects, such as bingo-type balls or tickets, each assigned a particular game value, or an electronic device capable of generating random game values or it may be printed numbers of a deck of cards placed in the second shoe.

In another embodiment, the second shoe may have promotional offerings to entice the player to play longer or as marketing tools to bring back players to the gaming establishment. For example, when a certain, predefined event happens, such as a player getting a Blackjack, the player may qualify to receive one or more promotional cards from the second shoe. In one embodiment, the cards in the second shoe may be electronic and interfaced to a gaming establishments related services such as shows and restaurants, which based on their availabilities are offered to the players as promotions.

A random game value generator in accordance with the teachings herein could be used as a device for promotional rewards by randomly awarding players upon occurrences of certain events. For example a casino may pre-print promotional rewards on a set of cards, then a dealer shuffles the cards and places them in the second shoe for random drawing when a player gets a blackjack. In an alternative embodiment, the cards could be in an electronic format and displayed to players on an electronic display located on one or more random game value generators. In this embodiment, a plurality of random game generators distributed throughout a casino, each for providing random game values to a respective gaming area, could be in wireless communication with game management system 112, or some other system, such as advertisement server 114, operated by, or on behalf of, a gaming establishment. Advertisement server 114 may be configured to dynamically display promotions related to the particular gaming establishment, or of other goods and services provided by others. As an example, if a restaurant or a show in a particular casino is not sold out for a specific time or period, advertisement server 114 may provide an advertisement to the plurality of random game value generators distributed throughout the casino for display on each random electronic game value generator.

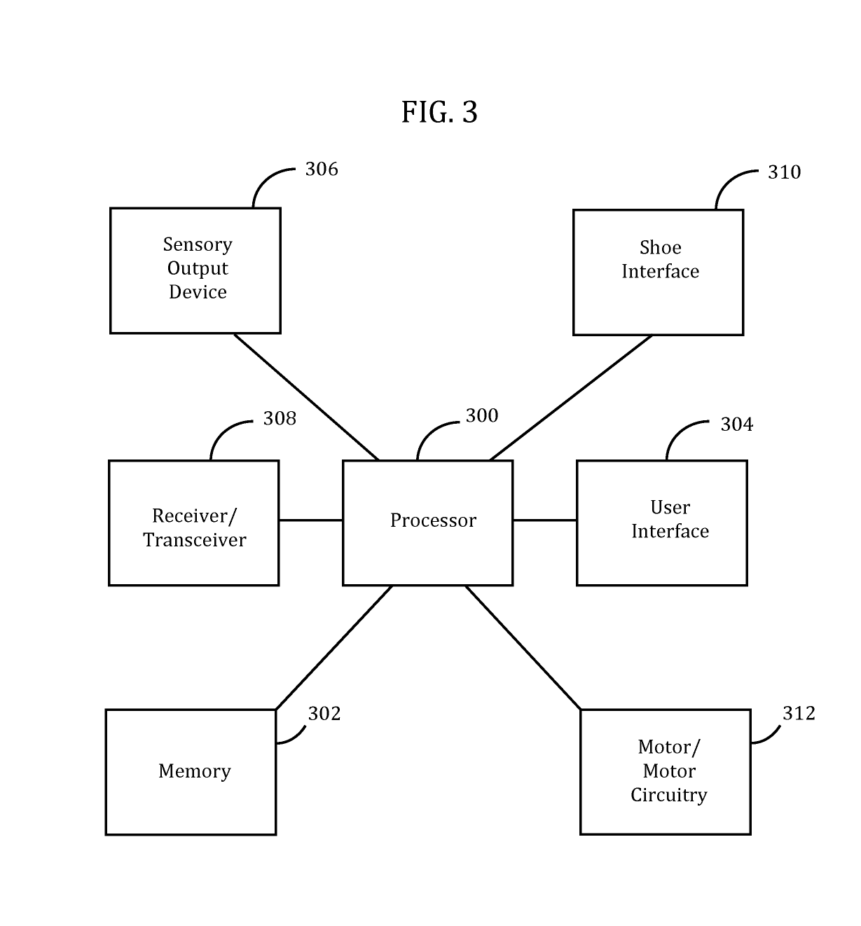

FIG. 3 is a functional block diagram of one embodiment of random game value generator 104 or 106, such as the bottom and top card shoes shown in FIG. 2, respectively. Shown are processor 300, memory 302, user input 304, sensory output device 306, receiver/transceiver 308, optional second shoe interface 310, and optional motor/motor circuitry 312. It should be understood that in some embodiments, not all of the functional blocks shown in FIG. 3 are necessary for the proper operation of random game value generator 104, and that some functionality has been omitted for purposes of brevity and clarity. It should also be understood that in embodiments where a primary game value generator is used in conjunction with a secondary game value generator, such as the double-deck card shoe shown in FIG. 2 (or in a number of other embodiments, such as primary and secondary bingo ball blowers, keno ball blowers, roulette wheels, etc.), each of primary random game value generator and secondary game value generator could comprise the aforementioned elements in order to operate independently from one another, or, in another embodiment, some of the functional elements could reside in one generator (for example, receiver/transceiver 308, processor 300 and memory 302), while other functional elements reside in the secondary generator (such as the sensory output device 306), where the two generators could be electronically coupled together via a connector, hard wiring, or wireless components.

Processor 300 comprises a general-purpose microprocessor well known in the art or it may comprise a custom or semi-custom ASIC able to carry out the functionality required for random game value generator 104 to receive communication signals from one or more remote devices, such as win determination device 110, game management system 112, advertisement server 114, or detector 108, process the signals, and cause on or more actions to occur in response to processing the signals. Processor 300 generally executes processor-executable instructions stored in one or more storage devices, such as memory 302, that control the functionality of random game value generator 104. Examples of memory 302 comprise one or more electronic memories such as RAM, ROM, flash memory, EEPROMs, UVPROMs, etc.

User interface 304 comprises one or more pushbuttons, switches, knobs, levers, touch-sensitive devices, card readers, microphone, camera, or other devices for a user to control operation of random game value generator 104. For example, a first pushbutton may be used to signal processor 300 that a new game is about to begin, that a current game has ended, to enter a number of players at gaming area 102 ready to play the next round of play, to start or stop a celebration of when an event has occurred, such as when a player achieves an exceptional game achievement (such as getting a Blackjack, getting a high hand such as a straight flush or four of a kind, for winning a jackpot, etc.). User interface 304 could also comprise one or more lights, LEDs, display devices, speakers, etc. to provide information to a user of random game value generator 104.

Sensory output device 306 comprises one or more audio and/or visual display devices for presenting a “celebration” to one or more players at gaming area 102 upon the occurrence of an event, such as receiving a Blackjack, obtaining a straight flush, or other event. In one embodiment, sensory output device 306 comprises a string of LEDs positioned around a perimeter of random game value generator 104, as shown in FIG. 3 that are caused to illuminate in one or more patterns when a predetermined event has occurred. In another embodiment, sensory output device 306 is located nearby or around random game value generator 104 and in communication with random game value generator 104 and/or win determination device 110, game management system 112, and/or dealer interface 116. Sensory output device 306 could further comprise a small amplifier and speaker for playing a sound such as music when a predetermined event has occurred, in addition or alternative to the LEDs. Sensory output device 306 could, in addition or alternatively, comprise an electronic display device, such as one or more LED display screens mounted on one or both sides of random game value generator 104, for presenting photos, videos, advertisements, or some other visual information to players after an event has occurred. The display could also present real-time information about the game's progress and outcome to the game participants. The data displayed could be for data received from other systems and devices such as number of cards dealt, value or summary of cards dealt, number of cards left in a shoe, a mystery or random bonus, bets made, number of hands won, outcome of a game, etc.

In another embodiment, sensory output device 306 comprises an electronic display device configured to display game-based statistics and/or data, such as a number of cards dealt in a round of game play or a cumulative number of cards dealt over a predetermined timer period, such as an hour, day, week, etc. The data could comprise a value or summary of cards dealt, a number of cards left in random game value generator 104, a mystery or random bonus, number and dollar value of bets made during a predetermined time period or during any round of game play, a number of hands won or lost, outcomes of gaming rounds, etc. This information may be determined by processor 300 as it receives information from detector 108 as game values are provided to players.

Receiver/transceiver 308 comprises hardware and/or software configured to receive and/or send electronic communication signals to win determination device 110, game management system 112, advertisement server 114, detector 108, and/or external audio/video devices/systems, in conjunction with receiver/transceiver 308. Receiver/transceiver 308 typically comprises one or more circuits/software well known in the art for receiving and/or sending wireless communication signals over-the-air in conformance with one or more well-known wireless standards, such as Wi-Fi, RF, Bluetooth, etc., in accordance with modern network protocols, such as TCP/IP, RS-232, or other well-known protocols. In another embodiment, receiver/transceiver 308 could comprise circuitry for providing wired communications, such as an Ethernet interface.

Optional second shoe interface 310 comprises a port, connector, or other electronic coupling device for providing electronic signals between primary shoe 104 and second shoe 106. Interface 310 is useful in embodiments where primary shoe 104 and second shoe 106 are separable and where one shoe or the other does not contain the necessary components to receive and process signals from win determination device 110, game management system 114, advertisement server 114, or detector 108. For example, if second shoe 106 does not contain processor 300, memory 302, but does comprise sensory output device 306 in the form of a small amplifier, speaker, and a string of LED lights, interface 310 can be used to provide signals from processor 300 located in primary shoe 104 to cause sound to be emitted from the speaker and to cause the LED lights to flash or otherwise illuminate in a variety of ways.

Optional motor/motor circuitry 312 is used in embodiments where a lever is used to block/allow access to cards in a card shoe during game play, typically used in the double deck card shoe embodiment shown in FIGS. 2, 5 and 6. Processor 300 controls motor circuitry that drives a small electric motor that causes the lever to move positions in order to block/allow access to the cards. Such motor circuitry and motors are well-known in the art.

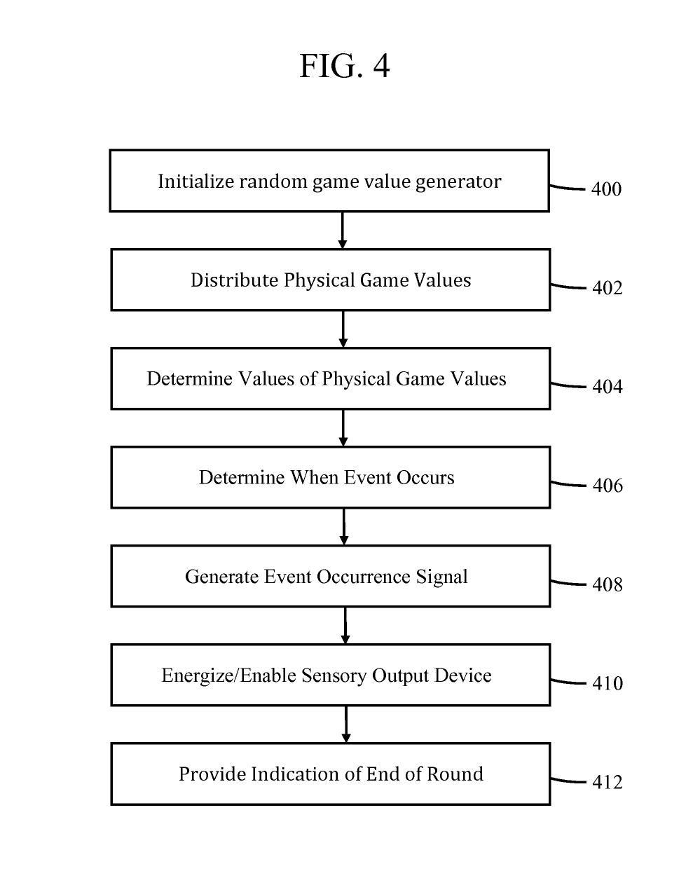

FIG. 4 is a flow diagram illustrating one embodiment of a method for providing audio and visual responses to certain events as they occur in a gaming establishment, performed by one or more processors 300 within random game value generator 104, 106 or both executing processor-readable instructions stored in one or more memories 302, unless otherwise noted. While the steps described with respect to FIG. 4, below, are in terms of a single card shoe, it should be understood that the steps could apply to different types of random game value generators, such as it should be understood that in some embodiments, not all of the steps shown in FIG. 4 are performed and that the order in which the steps are carried out may be different in other embodiments. It should be further understood that some minor method steps have been omitted for purposes of brevity and clarity.

The method begins at block 400, where a live dealer initializes random game value generator 104, win determination device 110 and/or game management system 112 to signal the start of a round of game play using dealer interface 116. The dealer may, alternatively or in addition, indicate the number of players who are currently playing the game or will otherwise receive game values.

At block 402, physical game values are distributed to each player by the dealer from random game value generator 104.

At block 404, the values of the physical game values are determined by detector 108, generally as the physical game values are distributed to the players. The game values are then provided by detector 108 to random game value generator 104, win determination device 110, game management system 112 and/or dealer interface 116.

At block 406, win determination device 110, game management system 112, random game value generator 104, dealer interface 116 and/or the live dealer, determines whether an event has occurred relating to the game. The event is generally an exciting, interesting, or otherwise noteworthy result related to the game. For example, in a game of Blackjack, events may be defined such as “Player Blackjack” and “Dealer Bust”. In poker, events may comprise any hand better than a full house. In Bingo, an event may comprise a complex Bingo pattern being completed by a player, such as a player completing a large “X” pattern on his or her Bingo card. An event may be determined by any of the aforementioned devices using processor-executable code stored in memory, which is generally well-known in the art, and/or an event may be determined by the dealer by visually observing results of the game as it progresses until completion.

Events may also be defined for conditions that occur outside the game being played. For example, an event may be defined as when any player within a casino hits a progressive jackpot on a table game in excess of $50,000 USD, reported by game management system 112, or when an extraordinary game result, such as a royal flush, occurs on another gaming table, also as reported by game management system 112. An event may be defined as when advertisement server 114 is informed of a time-sensitive condition, such as when a restaurant or a form of entertainment offered by a casino, such as a show, is not sold out or only a limited number of seats are available. Events may also be defined as promotion of upcoming parties or matches such as a New Year's party or a boxing match to be held at the casino's arena. When any of these events are determined to have occurred by either game management system 112 or advertisement server 114, a signal is sent by these devices to random game value generator 104 to cause random game value generator 104 to perform one or more actions. In one embodiment, the signal comprises information pertaining to the event that was determined. For example, in an example where an event is defined as when any poker player has raked a pot greater than $20,000 USD, the signal from game management system 112 to random game value generator 104 may comprise an event type (i.e., “Large Pot”), the dollar value of associated with the event (i.e., “$20,000), a game type related to the event (i.e., “5/10 Draw Poker”). In the case of advertisement server 114, the signal may comprise audio and/or video signals pertaining to various promotions related to the particular gaming establishment, or of other goods and services provided by others.

At block 408, a signal is generated by win determination device 110, game management system 112, random game value generator 104, and/or dealer interface 116 to indicate that an event has occurred. In the case of win determination device 110, game management system 112, and/or dealer interface 116, the signal is provided to random game value generator 104 via wired and/or wireless means.

At block 410, processor 300 receives the signal from win determination device 110, game management system 112, and/or dealer interface 116 and, in response, energizes or enables sensory output device 306 in a predetermined fashion, for example, to cause a string of LED lights mounted around a perimeter of random game value generator 104 to flash in a particular sequence in accordance with processor-executable instructions stored in memory 302, to cause a speaker on random game value generator 104 play a prerecorded song stored in memory 302, and/or to display a still advertisement, photo, or video on an electronic display located on random game value generator 104. The energization or enablement of sensory output device 306 typically remains for a predetermined time period, such as five seconds, before processor 300 de-energizes or disables sensory output device 306, causing the audible and/or visual stimulus to cease.

In one embodiment, processor 300 selects one or more actions stored in memory 302, based on one or more characteristics of the event. For example, processor 300 may determine that player number 3 seated at a Blackjack table received a Blackjack, based on a signal from win determination device 110, game management system 112, and/or dealer interface 116, or processor 300 may self-determine that a Blackjack occurred based on electronic game values provided by detector 108. In this case, processor 300 determines that LEDs mounted to random game value generator 104 should flash in unison for five seconds based on data stored in memory 302 in association with a Blackjack occurring for player number 3. Different actions may be defined for each player position at a table, or upon other characteristics, such as the type of event that occurred (i.e., “Dealer Bust”, “Player Blackjack”, etc.) a number of times an event has occurred for a particular player (whereupon the actions become escalating, such as playing louder music each time an event occurs, flashing the LEDs more quickly, etc.) or the relative odds of particular events occurring (whereupon more rare events result in a greater number of actions, and/or louder, longer, and/or more exciting actions are performed).

In addition to the foregoing, random game value generator 104 may cause other devices to perform one or more actions upon the occurrence of an event. For example, processor 300 may cause one or more video monitors to play a celebratory video upon the occurrence of an event, cause an external sound system to play celebratory music, etc. In this embodiment, processor 300 causes receiver/transceiver 308 to transmit signals that are compatible with such audio/video equipment in use by a gaming environment.

At block 412, after the one or more predetermined actions have occurred, the dealer may provide an indication to dealer interface 116 or random game value generator 104 that the round of play has ended. This information may enable win determination device 110, game management system 112, and/or random game value generator 104 to determine when an event occurs. For example, by knowing that a round of game play has ended, win determination device 110 may be reset, so that the next electronic game values received from detector 108 are known to be new game values.

While the foregoing disclosure shows illustrative embodiments of the invention, it should be noted that various changes and modifications could be made herein without departing from the scope of the invention as defined by the appended claims.

I claim:

1. A random game value generator for generating random, physical game values for use in a non-electronic game played in a gaming establishment, comprising:
a sensory output device disposed around the random game value generator;
a memory for storing processor-executable instructions; and
a processor, coupled to the sensory output device and the memory, for executing the processor-executable instructions that cause the random game value generator to:
determine that an event related to a gaming establishment has occurred while the non-electronic game is played that uses at least some of the plurality of physical game values; and
in response to determining that the event has occurred, enabling the sensory output device for a predetermined time period.

2. The random game value generator of claim 1, wherein the sensory output device comprises a plurality of lights disposed around the housing.

3. The random game value generator of claim 1, wherein the sensory output device comprises a string of LEDs.

4. The random game value generator of claim 1, wherein the sensory output device comprises a speaker for generating an audible signal.

5. The random game value generator of claim 1, wherein the sensory output device comprises an electronic display device.

6. The random game value generator of claim 1, wherein the event comprises a player of the non-electronic game achieving a predetermined game result.

7. The random game value generator of claim 1, wherein the event comprises a condition unrelated to the non-electronic game but related to the gaming establishment.

8. The random game value generator of claim 1, wherein the non-electronic game is conducted by a live gaming establishment employee and the live gaming establishment employee participates in the non-electronic game against players who play the non-electronic game, wherein the event comprises the live gaming establishment employee losing a round of game play.

9. The random game value generator of claim 1, wherein the instructions that cause the random game value generator to determine that an event has occurred comprises instructions that causes the random game value generator to:
receive an indication from a remote device that the event has occurred.

10. The random game value generator of claim 1, further comprising instructions that cause the random game value generator to transmit a signal to a remote device in response to determining that the event has occurred that causes the remote device to take at least one action in response to receiving the signal.

11. A method performed by a random game value generator for generating random, physical game values used in a non-electronic game in a gaming establishment, comprising:
determining that an event related to the gaming establishment has occurred while the non-electronic game is played; and
in response to determining that the event has occurred, enabling a sensory output device located around the random game value generator.

12. The method of claim 11, wherein the sensory output device comprises a plurality of lights.

13. The method of claim 11, wherein the sensory output device comprises a string of LEDs.

14. The method of claim 11, wherein the sensory output device comprises a speaker for generating an audible signal.

15. The method of claim 11, wherein the sensory output device comprises an electronic display device.

16. The method of claim 11, wherein the event comprises a player of the non-electronic game achieving a predetermined game result.

17. The method of claim 11, wherein the event comprises a condition unrelated to the non-electronic game but related to the gaming establishment.

18. The method of claim 11, wherein the non-electronic game is conducted by a live gaming establishment employee and the live gaming establishment employee participates in the non-electronic game against players who play the non-electronic game, wherein the event comprises the live gaming establishment employee losing a round of game play.

19. The method of claim 11, further comprising:
receiving an indication from a remote device that the event has occurred.

20. The method of claim 11, further comprising transmitting a signal to a remote device in response to determining that the event has occurred that causes the remote device to take at least one action in response to receiving the signal.
